(19) United States
(12) Patent Application Publication
(10) Pub. No.: US 2020/0333155 A1
(43) Pub. Date: Oct. 22, 2020

(54) CLIENT AND PROSPECT APP

(71) Applicant: Specialty Risk Holdings, LLC, Carthage, MO (US)

(72) Inventors: Kevin Charleston, Reeds, MO (US); Chance Morgan, Webb City, MO (US); Colt Atwood, Carthage, MO (US)

(21) Appl. No.: 16/387,863

(22) Filed: Apr. 18, 2019

(51) Int. Cl. G01C 21/36; G06Q 40/08; G06Q 30/00; H04L 29/08; G06F 3/0488; G01C 21/28

(52) U.S. Cl. CPC G01C 21/367; G06Q 40/08; G06Q 30/01; G01C 21/28; H04L 67/26; G06F 3/0488; H04L 67/18

(57) ABSTRACT

A client and prospect app includes interfaces for sales reps, administrators and support staff. The client and prospect app includes the ability to define a route for a trip on a map, and to display clients and prospects within a defined distance of the route. An administrator can define mandatory and/or suggested tasks tied to geographical locations, and when a trip for a rep is defined with a route within a defined distance of those geographical locations, mandatory and suggested tasks can be automatically assigned to the rep making the trip and displayed on the map. The client and prospect app can also access a property identification service so a user of the app can click on a property on a map in the app, and the property identification service accesses public land records to identify the owner of the property and to display the owner information in the app.

### BACKGROUND

### 1. Technical Field

This disclosure generally relates to customer relations management, and more specifically relates to an app for managing clients and prospects.

### 2. Background Art

Many systems have been developed for customer relations management. These systems typically include the ability to delegate tasks to team members with defined due dates, provide email reminders, and provide status reports. The goals of some customer relations management systems include increasing productivity and making clients happy.

Many businesses have specific requirements that are not well-served by commercially-available customer relations management software. For example, the business of selling home, farm and business insurance has specific needs that are not met by most commercially-available customer relations management software.

### SUMMARY

A client and prospect app is part of a client and prospect management system. The client and prospect app can run on many different systems, including computer systems in an office, tablet computers, smart phones, etc. The client and prospect app includes interfaces for sales reps, administrators and support staff. The client and prospect app includes the ability to define a route for a trip on a map, and to display clients and prospects within a defined distance of the route. An administrator can define mandatory and/or suggested tasks tied to geographical locations, and when a trip for a rep is defined with a route within a defined distance of those geographical locations, mandatory and suggested tasks can be automatically assigned to the rep making the trip and displayed on the map. The client and prospect app can also access a property identification service so a user of the app can click on a property on a map in the app, and the property identification service accesses public land records to identify the owner of the property and to display the owner information in the app. The client and prospect app can display clients and prospects on a map coded according to defined expiration dates, priority information or notes corresponding to clients and prospects. The client and prospect app also supports sending mass notification messages to users, clients and prospects using selectable criteria.

The foregoing and other features and advantages will be apparent from the following more particular description, as illustrated in the accompanying drawings.

### BRIEF DESCRIPTION OF THE DRAWING(S)

The disclosure will be described in conjunction with the appended drawings, where like designations denote like elements, and:

FIG. 1 is a block diagram of a client and prospect management system;

FIG. 2 is a block diagram showing one suitable implementation for a device with a client and prospect app shown in FIG. 1;

FIG. 3 is a block diagram of one suitable implementation of the client and prospect app in FIGS. 1 and 2 that includes three interfaces;

FIG. 4 is a table showing rep functions accessible via the rep interface 310 in FIG. 3;

FIG. 5 is a table showing administrator functions accessible via the administrator interface 320 in FIG. 3;

FIG. 6 is a table showing support functions accessible via the support interface 330 in FIG. 3;

FIG. 7 is a flow diagram of a method for displaying clients and prospects on a map;

FIG. 8 is one suitable example for a map that shows a route from Carthage, Mo. to St. Louis, Mo.;

FIG. 9 shows the map in FIG. 8 with clients and prospects marked on the map;

FIG. 10 is a flow diagram of a method for an administrator to add information relating to trips and/or routes for reps;

FIG. 11 shows the map in FIG. 9 with the addition of a mandatory task and a suggested task;

FIG. 12 is a flow diagram of a method for an administrator to define mandatory and suggested tasks for clients, prospects and geographical locations;

FIG. 13 is a flow diagram of a method for adding mandatory and suggested tasks to a rep trip;

FIG. 14 is a flow diagram of a method for notifying an administrator when a task is near an expiration date;

FIG. 15 is a flow diagram of a method for determining ownership of a property by selecting the property in a map;

FIG. 16 is a flow diagram of a method for adding prospects to the client and prospect app;

FIG. 17 is a flow diagram of a method for identifying clients and prospects near a person's location;

FIG. 18 is a flow diagram of a method that requires a new task for a prospect be scheduled before closing an old task;

FIG. 19 is a flow diagram of a method for marking clients and prospects on a map by expiration date;

FIG. 20 is a flow diagram of a method for generating rep reports;

FIG. 21 is a flow diagram of a method for automatically generating a mandatory trip to address a mandatory task that is nearing expiration;

FIG. 22 is a table showing possible additional functions for the client and prospect app;

FIG. 23 shows a sample display of a prospect with selectable criteria;

FIG. 24 is a sample mass notification message for automatically sending messages to clients/prospects according to the criteria selected for each client, such as shown for John Smith in FIG. 23;

FIG. 25 is a display of senders and recipients of a mass notification message; and

FIG. 26 is a flow diagram of a method for sending mass notification messages.

### DETAILED DESCRIPTION

A client and prospect app is part of a client and prospect management system. The client and prospect app can run on many different systems, including computer systems in an office, tablet computers, smart phones, etc. The client and prospect app includes interfaces for sales reps, administrators and support staff. The client and prospect app includes the ability to define a route for a trip on a map, and to display clients and prospects within a defined distance of the route. An administrator can define mandatory and/or suggested tasks tied to geographical locations, and when a trip for a rep is defined with a route within a defined distance of those geographical locations, mandatory and suggested tasks can be automatically assigned to the rep making the trip and displayed on the map. The client and prospect app can also access a property identification service so a user of the app can click on a property on a map in the app, and the property identification service accesses public land records to identify the owner of the property and to display the owner information in the app. The client and prospect app can display clients and prospects on a map coded according to defined expiration dates, priority information or notes corresponding to clients and prospects. The client and prospect app also supports sending mass notification messages to users, clients and prospects using selectable criteria.

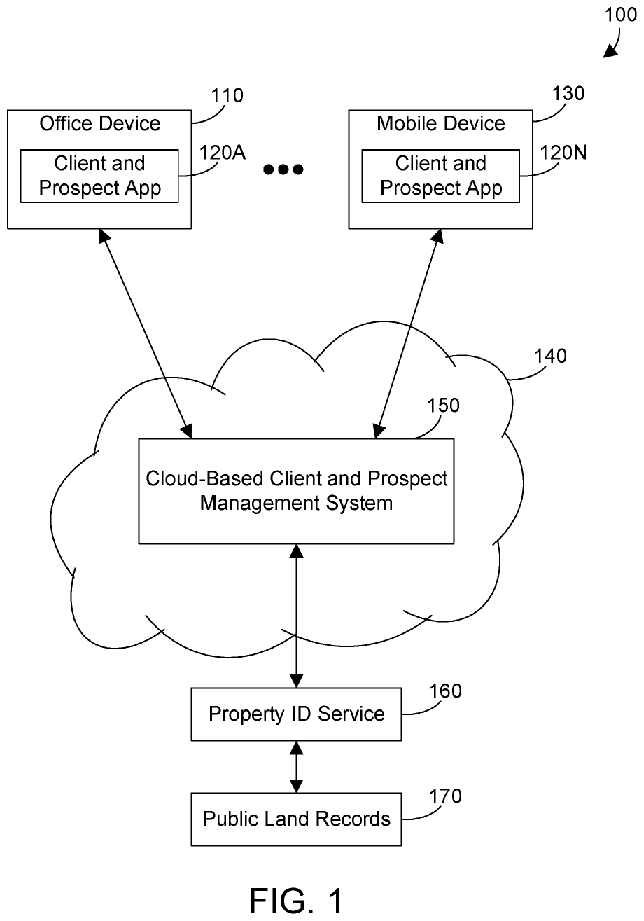

Referring to FIG. 1, a system 100 is a client and prospect management system. System 100 includes a cloud-based client and prospect management system 150 in a cloud 140 that interacts with multiple devices, such as office device 110, . . . , and mobile device 130. Cloud 140 can include any suitable public or private cloud. The system 100 for a business can include multiple office devices and/or multiple mobile devices for each sales representative, administrator and support person. The devices, such as 110, . . . , 130, each include a client and prospect app 120, which is software that is discussed in detail herein. The client and prospect app is shown in FIG. 1 as 120A, . . . , 120N. Note the specific code for each app 120A, . . . , 120N can be different, such as, for example due to a difference in operating systems of the devices. However, each app on each device most preferably provides similar functions that can be adapted to the features of the device. For example, a list of prospects displayed on the screen of a smart phone may be in one format due to the relatively small display size of the smart phone, while the same list of prospects displayed on a display of a desktop computer may be in a different format due to the larger display. Thus, the client and prospect app can provide similar functions described herein regardless of the specific device executing the app. The client and prospect app 120, in conjunction with the cloud-based client and prospect management system 150, provides a system for managing clients and prospects for an organization that has a sales force. An insurance office that writes insurance policies for homes, farms and businesses is one suitable example of an organization that could use the client and prospect app disclosed herein.

The cloud-based client and prospect management system 150 is coupled to a property identification service 160 that provides a portal for accessing public land records 170. While the property identification service 160 is shown in FIG. 1 coupled to the cloud-based client and prospect management system 150, in an alternative configuration, the client and prospect app, such as 120A, . . . , 120N, could access the property identification service 160 directly. The property identification service 160 allows a user of the client and prospect app to view ownership information for a property displayed in the app by querying the property identification service 160 for the owner information from the public land records 170, which information is then displayed in the app. One suitable example for the property identification service 160 is known as Landglide, which provides ownership information for land by accessing public land records 170.

While FIG. 1 shows a cloud-based client and prospect management system 150, in an alternative implementation, a similar client and prospect management system could be run on a server or desktop computer system, rather than being cloud-based. In yet another alternative implementation, the client and prospect apps in the devices could include all the functions of the cloud-based client and prospect system 150, thereby eliminating the need for the cloud-based client and prospect management system 150. However, in the most preferred implementation, the cloud-based client and prospect management system 150 includes all information for all client and prospect apps for all devices for all users, so this information is backed up to the cloud and can be managed efficiently by administrators.

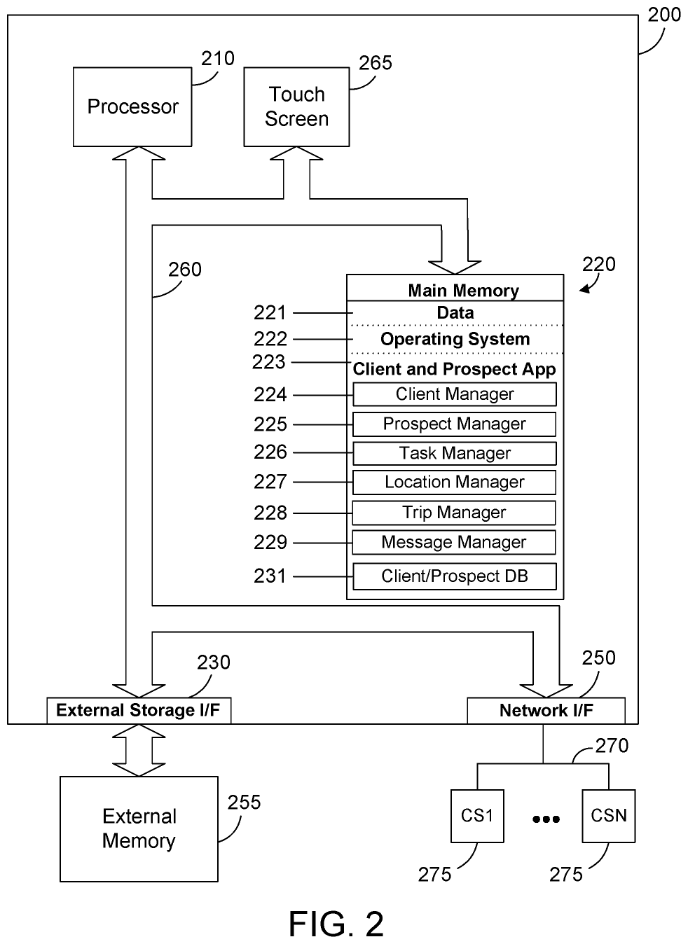

Referring to FIG. 2, a device 200 represents any suitable type of device that can run the client and prospect app, including without limitation a smart phone, tablet computer, electronic book reader, notebook computer, laptop computer, desktop computer, gaming console, smart watch, smart TV, security touch pad, smart home device, etc. Those skilled in the art will appreciate that the disclosure herein applies equally to any type of device capable of running the client and prospect app. As shown in FIG. 2, one suitable device 200 is a mobile device that includes a touch screen 265, such as a smart phone or a tablet computer, for example. Device 200 comprises one or more processors 210, a main memory 220, an external storage interface 230, a network interface 250, and a touch screen 265. These system components are interconnected through the use of a system bus 260. External storage interface 230 is used to access external memory 255. One specific type of external memory 255 is non-volatile memory on an external device, such as an SD card, a micro-SD card, or a flash drive. The external memory 255 may include any suitable computer readable storage medium as discussed in more detail below.

Main memory 220 preferably contains data 221, an operating system 222 and a client and prospect app 223. Data 221 represents any data that serves as input to or output from any program or the operating system 222 in device 200. Operating system 222 could be any suitable operating system. Known operating systems include the iOS operating system developed by Apple Computer, the Android operating system developed by Google, the Windows Phone operating system developed by Microsoft, Windows developed by Microsoft, Linux, AIX, etc. Client and prospect app 223 is one suitable example for the client and prospect apps 120A, . . . , 120N shown in FIG. 1. The client and prospect app 223 includes a client manager 224, a prospect manager 225, a task manager 226, a location manager 227, a trip manager 228, a message manager 229, and a client/prospect database 231. The client manager 224 allows users of the client and prospect app 223 to manage clients in the client/prospect database 231. A client is most preferably a current or past customer or client. The prospect manager 225 allows users to manage prospects in the client/prospect database 231. A prospect can include any person or entity that is not a current client, including past clients that are not current clients. The task manager 226 allows assigning and tracking tasks for users of the client and prospect app 223. The location manager 227 performs functions according to the location of the device 200, such as displaying a map corresponding to the location, querying an external property identification service, such as 160 shown in FIG. 1, to determine ownership information for a property identified in the app, and for displaying clients and prospects in the client/prospect database within a defined distance of the device 200. The trip manager 228 allows defining a trip by selecting a route between two geographical points. The trip manager 228 displays a map of the route, and queries the client/prospect database 231 to determine clients and prospects within a defined distance, such as 20 miles (32 kilometers), of the route. The clients and prospects can then be displayed on the map. The clients and prospects can have indicators that vary according to expiration date, priority and notes. The shapes and/or colors of the indicators can indicate expiration date, priority and notes. The message manager 229 allows sending mass notification messages to users of the client and prospect management system 140, such as reps, administrators, and support staff, and to clients and prospects as well. The functions of the message manager 229 are discussed in more detail below with reference to FIGS. 23-26. The client/prospect database 231 is a database that includes clients and prospects. While the client/prospect database 231 is shown as a single database that includes both clients and prospects, it is equally within the scope of the disclosure and claims herein to provide a client database that is separate from a prospect database. Client/prospect database 231 is shown in FIG. 2 to visually suggest a place where both client and prospect data reside, regardless of whether this data is in one database or two separate databases.

Main memory 220 may include any suitable combination of different memory types. For example, main memory 220 could include dynamic random access memory (DRAM) that has a relatively small size and a fast access time and could also include non-volatile memory (NVRAM) that has a much larger size and a slower access time. Programs stored in NVRAM could then be loaded into the DRAM in order to be executed by the processor 210. This simple example shows the main memory 220 can include any suitable number and type of memories in any suitable hierarchy, whether currently known or developed in the future.

Processor 210 may be constructed from one or more microprocessors and/or integrated circuits. Processor 210 executes program instructions stored in main memory 220. Main memory 220 stores programs and data that processor 210 may access. When computer system 200 starts up, processor 210 initially executes the program instructions that make up operating system 222. Processor 210 also executes the client and prospect app 223.

Although device 200 is shown to contain only a single processor and a single system bus, those skilled in the art will appreciate that the client and prospect app may be executed on a device that has multiple processors and/or multiple buses. In addition, the interfaces that are used preferably each include separate, fully programmed microprocessors that are used to off-load compute-intensive processing from processor 210. However, those skilled in the art will appreciate that these functions may be performed using I/O adapters as well.

Touch screen 265 is a display that allows the user to select functions on the device 200 by touching the touch screen 265 and/or by making one or more gestures on the touch screen 265, including a finger swipe and a finger tap. Touch screen 265 may allow a user to interact with any suitable touch sources, including a finger, multiple fingers (including the thumb), and a stylus or other non-finger touch device. Touch screens on touch screen devices are well-known in the art. Of course, device 200 could include input devices other than a touch screen, such as a keyboard, mouse, etc., and could include other display devices, such as a computer monitor.

Network interface 250 is used to connect device 200 to a network 270. Network interface 250 broadly represents any suitable way to interconnect electronic devices, such as device 200, to other devices 275, such as computer systems CS1, . . . , CSN shown at 275 in FIG. 2, regardless of whether the network 270 comprises present-day analog and/or digital techniques or via some networking mechanism of the future. Network interface 250 preferably includes a combination of hardware and software that allow communicating on the network 270. The network interface 250 can include multiple different network interfaces. For example, network interface 250 could include a wireless interface for communicating with a 4G network, a Wi-Fi interface for communicating with a Wi-Fi network, and a Bluetooth interface for communicating with other devices via Bluetooth, a Near Field Communication interface, or any other type of suitable network interface, whether currently known or developed in the future. Software in the network interface 250 preferably includes a communication manager that manages communication with other devices 275 via network 270 using a suitable network protocol. Many different network protocols can be used to implement a network. These protocols are specialized computer programs that allow computers to communicate across a network. TCP/IP (Transmission Control Protocol/Internet Protocol) is an example of a suitable network protocol that may be used by the communication manager within the network interface 250.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

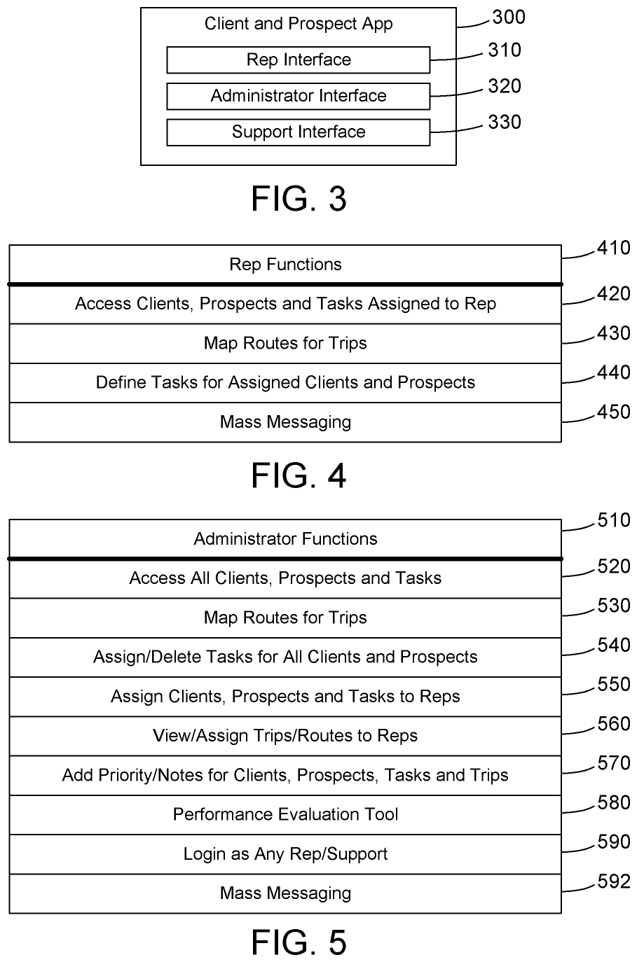

Referring to FIG. 3, client and prospect app 300 is one suitable version of the client and prospect app 223 in FIG. 2 and the client and prospect apps 120A, . . . , 120N shown in FIG. 1. Client and prospect app 300 preferably includes a rep interface 310, an administrator interface 320, and a support interface 330. The rep interface 310 is an interface used by sales representatives of an organization. The term “representative” is often abbreviated herein as “rep.” The administrator interface 320 is an interface used by administrators of the organization. The support interface 330 is an interface used by support staff of the organization. The functions available via the rep interface 310, the administrator interface 320, and the support interface 330 are shown in FIGS. 4-6 and are discussed further below.

A table 410 in FIG. 4 shows functions available to reps via the rep interface 310. The rep functions include the ability access clients, prospects and tasks assigned to the rep 420; map routes for trips 430; define tasks for assigned clients and prospects 440; and mass messaging 450. We assume each rep in an organization has assigned clients, prospects and tasks. These clients, prospects and tasks can be assigned to the rep by an administrator or by a support person. Once assigned to a rep, the rep can access all of the assigned clients, prospects and tasks 420. The rep can map routes for trips 430. In addition, the rep can define tasks for assigned clients and prospects 440. The rep can also perform mass messaging 450 to selected reps, administrators, support staff, clients and prospects according to selectable criteria.

Table 510 in FIG. 5 shows functions available to administrators via the administrator interface 320. The administrator functions include the ability to access all clients, prospects and tasks 520; map routes for trips 530; assign/delete tasks for all clients and prospects 540; assign clients, prospects and tasks to reps 550; view or assign trips/routes to reps 560; add priority or notes for clients, prospects, tasks and trips 570; a performance evaluation tool 580; the ability to login as any rep or support staff 590 so the administrator can see what the rep or support staff sees in their client and prospect app; and the ability to perform mass messaging 592 to selected reps, administrators, support staff, clients and prospects according to selectable criteria.

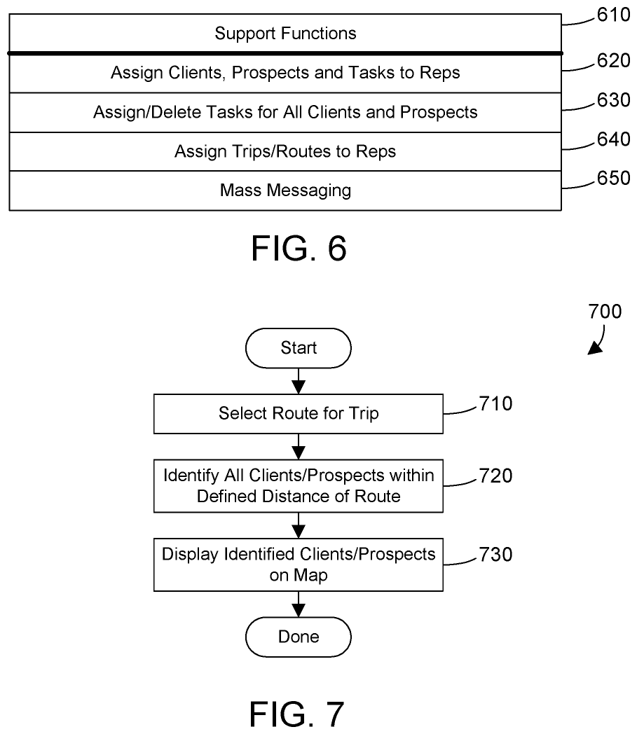

Table 610 in FIG. 6 shows functions available to support staff via the support interface 330. The support functions include the ability to assign clients, prospects and tasks to reps 620; assign/delete tasks for all clients and prospects 630; assign trips/routes to reps 640; and perform mass messaging 650 to selected reps, administrators, support staff, clients and prospects according to selectable criteria.

The reps, administrators and support staff are all users of the client and prospect app, so when the term “user” is used herein, it can mean any or all of these three. Each user will have rights defined by an administrator that gives the user the needed access. For example, if a user Sue Smith is a rep, an administrator can define Sue Smith as a rep, and provide a login for Sue Smith. The result is when Sue Smith logs in, she will have access to the rep functions 410. Thus, an administrator defines a user status as either a rep, an administrator, or support, and this definition gives each user access only to the functions corresponding to their user status, as shown in FIGS. 4-6.

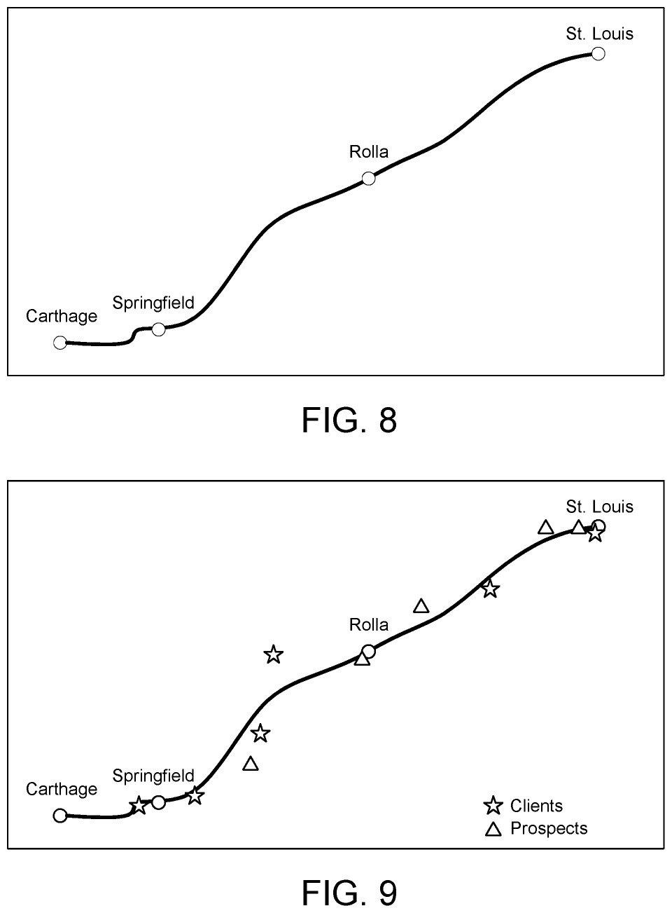

Referring to FIG. 7, a method 700 is preferably performed by the trip manager 228 shown in FIG. 2. A user selects a route for a trip (step 710). All clients and/or prospects within a defined distance of the route are identified (step 720). A suitable example for a defined distance is 20 miles (32 kilometers). Note, however, any suitable defined distance can be used. The identified clients and/or prospects are then displayed on the map (step 730). A simple example will illustrate. We assume a user in step 710 of FIG. 7 selects a route for a trip from Carthage, Mo. to St. Louis, Mo., as shown in FIG. 8. The trip manager will then query the client/prospect database 231 to determine which clients and prospects are within a defined distance of the selected route, such as 20 miles (32 kilometers). The clients and prospects are then displayed on the map of the route, as shown in FIG. 9, where the clients are represented by stars and the prospects are represented by triangles. When the user selects one of the displayed stars, the corresponding client information is displayed. Similarly, when the user selects one of the displayed triangles, the corresponding prospect information is displayed. The stars and triangles in FIG. 9 are different shapes of indicators for clients and prospects, respectively. However, similar information could be conveyed using color for the same shapes. Thus, both clients and prospects could be represented by hexagon indicators, with prospects displayed in red and clients displayed in blue. In a variation, the size of the indicators or colors can indicate different information on the display. For example, clients that have insurance policies that will expire within a month could be in dark blue, while clients that have insurance policies with longer terms could be in light blue. Similarly, prospects can be assigned expiration dates when they are entered into the system, and prospects with close expiration dates could be displayed in dark red while other prospects are displayed in light red. The size of the indicators on the display can also change according to date, priority, notes, etc. The ability to provide indicators in varying shapes, sizes and colors gives great power and flexibility in presenting useful information to the user on the display.

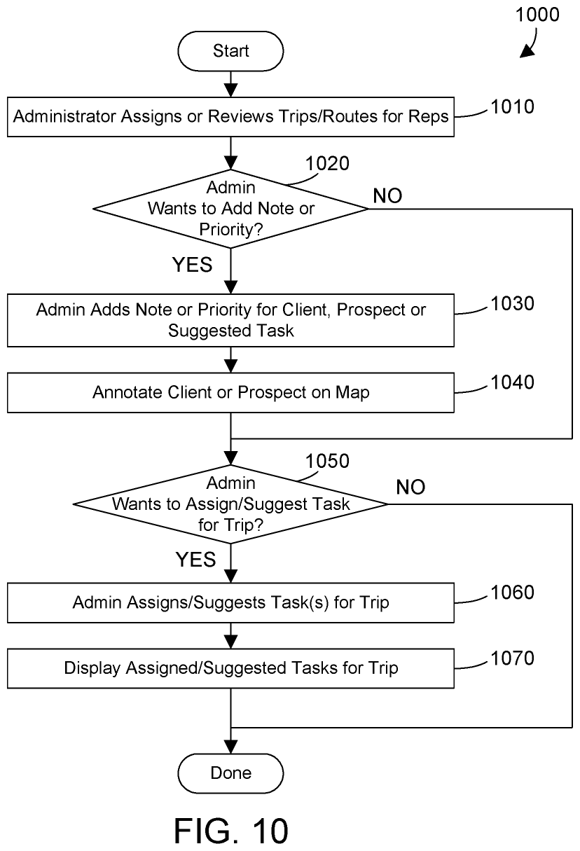

An administrator has the ability to enter information to manage the reps. Referring to FIG. 10, a method 1000 is preferably performed by the client and prospect app 223 in FIG. 2. An administrator assigns or reviews trips/routes for reps (step 1010). Note in the drawings, the term “admin” is sometimes used as an abbreviation for the word “administrator.” When the administrator does not want to add a note or priority to a contact or prospect for a trip (step 1020=NO), method 1000 proceeds to step 1050. When the administrator wants to add a note or priority to a client or prospect (step 1020=YES), the administrator adds a note or a priority for a client, prospect or suggested task (step 1030). The indicator for the client or prospect on the map is then annotated to indicate the note or priority (step 1040). One suitable example of annotation is adding a selectable flag or other indicator on or near a client or prospect indicator. Another suitable example of annotation is changing the size of the displayed client or prospect indicator. Yet another suitable example of annotation is changing the color of the displayed client or prospect indicator.

When the administrator does not want to assign or suggest a task for a trip (step 1050=NO), method 1000 is done. When the administrator wants to assign or suggest a task for a trip (step 1050=YES), the administrator assigns or suggests one or more tasks for a trip (step 1060). The assigned/suggested tasks for the trip are then displayed (step 1070). Method 1000 is then done. The assigned/suggested tasks for the trip can be displayed separately on the display of the route, or can be displayed as annotations to the client or prospect indicators. Thus, an assigned task for a particular client could result in the indicator for the client being enlarged and colored orange, and selecting the indicator or hovering over the indicator can result in displaying the assigned task.

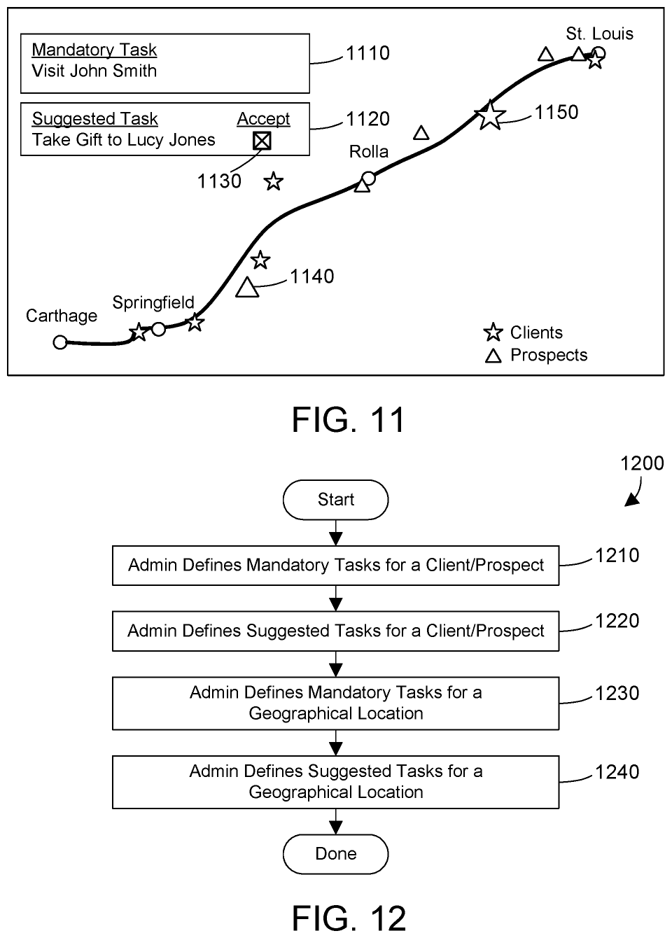

FIG. 11 illustrates some of the concepts discussed above with respect to FIG. 10. We assume for this example the user has selected a route as shown in FIG. 8, and in response, the trip manager has displayed the clients and prospects along this route as shown in FIG. 9. An administrator, in reviewing this proposed trip, can add a mandatory task, namely, Visit John Smith, and can add a suggested task, namely, Take Gift to Lucy Jones. The assigned task Visit John Smith is a mandatory task assigned by the administrator, and thus cannot be refused by the rep, and is displayed in a mandatory task box 1110. The suggested task Take Gift to Lucy Jones is displayed in a suggested tasks box 1120 that includes a checkbox 1130 the user can select to accept the task. When the user selects the checkbox 1130, the suggested task is assigned to the user for this trip. When the user does not select the checkbox 1130, the suggested task is not assigned to the user, but will remain a suggested task for the client Lucy Jones that can be assigned to a different user for another trip. We assume for this example John Smith is a prospect represented by the enlarged triangle at 1140 in FIG. 11, and Lucy Jones is a client represented by the enlarged star 1150 in FIG. 11. Note that instead of enlarging the indicators as shown in FIG. 11, different colors could be used to color-code client and prospect indicators according to mandatory and accepted suggested tasks.

Referring to FIG. 12, a method 1200 shows how an administrator can define mandatory and suggested tasks. An administrator defines one or more mandatory tasks for a client or prospect (step 1210). The administrator can also define one or more suggested tasks for a client or prospect (step 1220). In addition to defining tasks for a client or prospect, the administrator can also define one or more mandatory tasks for a geographical location (step 1230), and can define one or more suggested tasks for a geographical location (step 1240). Thus, an administrator could define a mandatory task for the city of St. Louis, Mo. to host a lunch for all clients and prospects in proximity to St. Louis. The next time a rep plans a trip to St. Louis, this mandatory task could be assigned to the rep. Defining tasks for a geographical location in steps 1230 and 1240 can also result in defining tasks for multiple clients and/or prospects. Thus, a task could be defined to “contact all prospects in St. Louis”, with the result that each prospect within a defined distance of St. Louis will have an associated task to contact the prospect on the next trip to St. Louis.

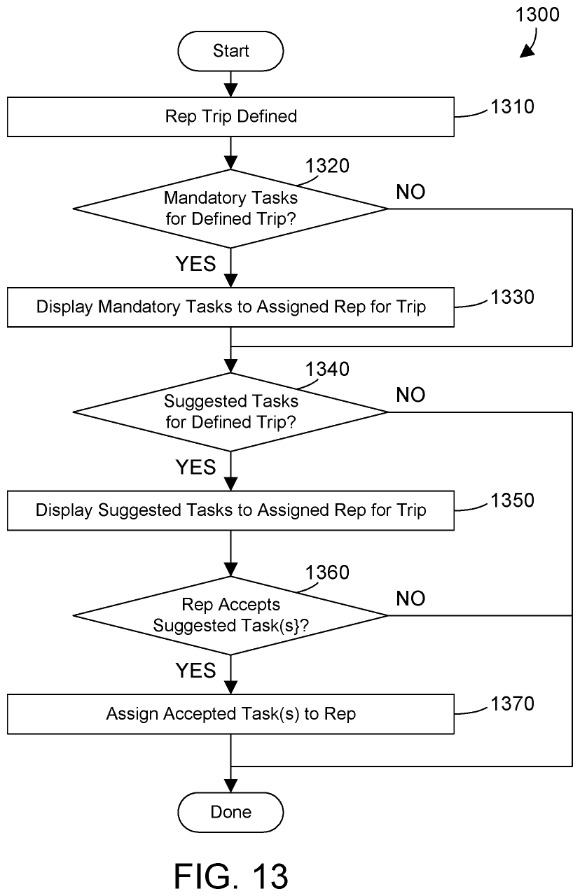

Referring to FIG. 13, a method 1300 is preferably performed by the trip manager 228 in FIG. 2. Method 1300 begins when a rep trip is defined (step 1310), either by a rep, by an administrator, or by a support person. When there are one or more mandatory tasks for the defined trip (step 1320=YES), the mandatory tasks are displayed to the assigned rep for the trip (step 1330). The display of mandatory tasks can be in a box such as 1110 in FIG. 11, or could be indicated by changing the color and/or size of an indicator for a client or prospect, where the mandatory tasks can be viewed when hovering over or after selecting a client or prospect. When there are no mandatory tasks for the defined trip (step 1320=NO), method 1300 proceeds to step 1340. When there are one or more suggested tasks for the defined trip (step 1340=YES), the suggested tasks are displayed to the assigned rep for the trip (step 1350) in any suitable way. For example, the suggested tasks can be in a box such as 1120 in FIG. 11 with an accept box 1130 the user can check to accept the suggested task. When the rep accepts the suggested task(s) (step 1360=YES), the accepted tasks are assigned to the rep (step 1370). When there are no suggested tasks for the defined trip (step 1340=NO), or when the rep does not accept any of the suggested tasks (step 1360=NO), method 1300 is done.

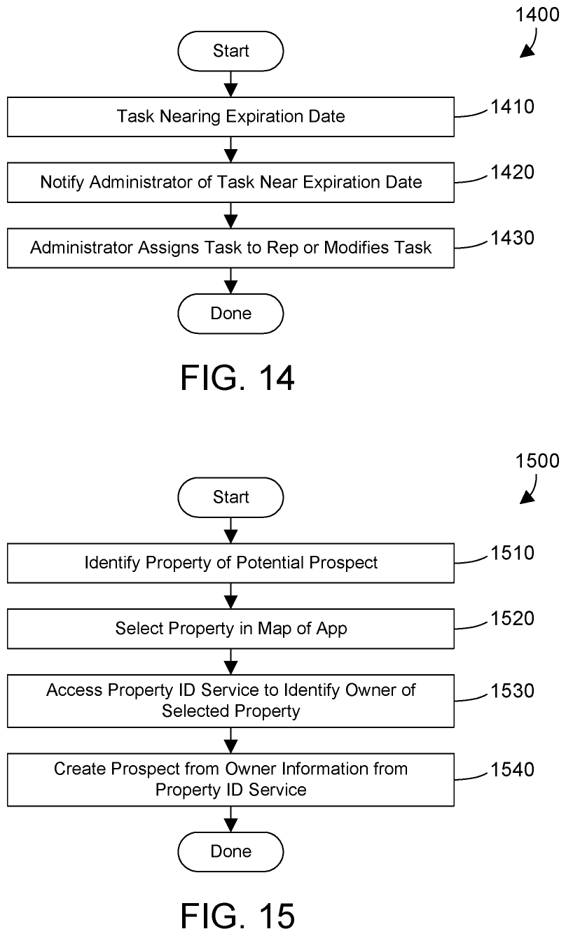

Referring to FIG. 14, a method 1400 is preferably performed by the task manager 226 in FIG. 2. A task is nearing a completion date (step 1410). In a preferred embodiment, what constitutes “nearing a completion date” can be defined in any suitable way, such as a predetermined time period (e.g., two weeks) from a specified completion date. An administrator is notified of the task that is near its expiration date (step 1420). The administrator can then assign the task to a rep, or modify the expiration date of the task (step 1430). Method 1400 is then done.

Referring to FIG. 15, a method 1500 is preferably performed by the location manager 227 in FIG. 2. A property of a potential prospect is identified (step 1510). The property is selected in the map of the app (step 1520). The app then accesses an external property identification service to identify the owner of the selected property (step 1530). One suitable known property identification service is Landglide, which provides a portal to public land records to determine who owns a selected property. Once the property identification service returns the data that identifies the owner of the selected property, a prospect can be automatically created from the owner information retrieved from the property identification service (step 1540). Method 1500 is then done. Method 1500 is especially useful when a rep wants to cold call the owner of a home, farm or business, and can thus have the ownership information in-hand when making the call.

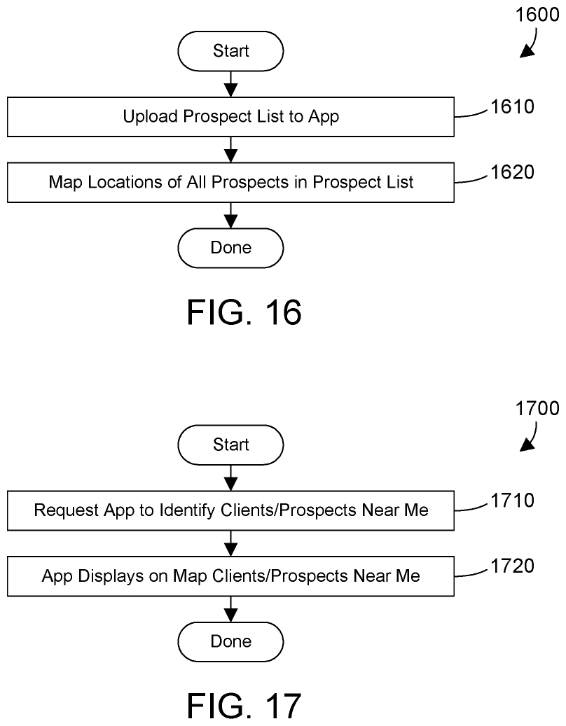

Referring to FIG. 16, a method 1600 is preferably performed by the prospect manager 225 in FIG. 2. A list of prospects can be uploaded to the app (step 1610). The locations of all prospects in the prospect list can be mapped in the app (step 1620). Method 1600 is then done. By mapping locations of all prospects in a newly-uploaded prospect list, a user can then define routes for trips to optimize contacting the prospects.

Referring to FIG. 17, a method 1700 is preferably performed by the location manager 227 shown in FIG. 2. A user can select for the app to identify clients and/or prospects near me (step 1710). Note the term “near me” preferably means within a defined distance, such as 20 miles (32 kilometers), of the mobile device the user is using, such as a smart phone. This could be useful, for example, when the user had unexpected time that can be used to contact clients or prospects, such as when a meeting that was scheduled to last the entire afternoon ends at 3:00 PM. The app displays on a map in the app the clients and/or prospects near the user (step 1720). Method 1700 is then done. Method 1700 allows a user to determine clients and prospects close by at any given point in time.

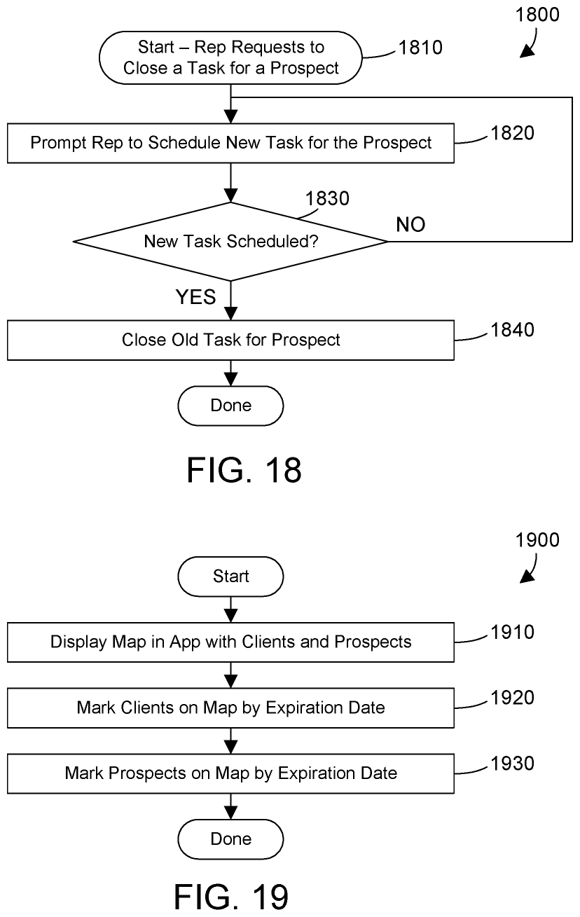

A method 1800 in FIG. 18 is preferably performed by the task manager 226 in FIG. 2. Method 1800 begins when a rep requests to close a task for a prospect (step 1810). The rep is prompted to schedule a new task for the prospect (step 1820). As long as the new task is not scheduled (step 1830=NO), method 1800 loops back to step 1820, until the rep schedules the new task (step 1830=YES), at which point the old task for the prospect is closed (step 1840). Method 1800 is then done. Method 1800 assures a prospect does not slip through the cracks by requiring a new task for a prospect be scheduled before a task can be closed.

Referring to FIG. 19, a method 1900 is preferably performed by the client and prospect app 223 in FIG. 2. A map is displayed in the app with clients and prospects (step 1910). For example, a display as shown in FIG. 9 shows clients and prospects. The clients on the map can be marked according to expiration date (step 1920). The prospects on the map can also be marked according to expiration date (step 1930). Method 1900 is then done. The expiration date for clients and prospects can be defined in any suitable way. In one specific example when using the app for selling insurance policies for homes, farms and businesses, the expiration date for clients could be the expiration date of the currently insurance policy. Note, however, the expiration date need not necessarily coincide with the expiration date of a policy. For example, an expiration date for a client that pays for a two year insurance policy can be set to one year so the client is contacted at least yearly to maintain the relationship with the client. The expiration date for prospects can be a date set by an administrator, such as six months from when the prospect is first entered into the app. The indicators for clients and prospects can be marked in any suitable way, including changing the color, shape and size of indicators on the display.

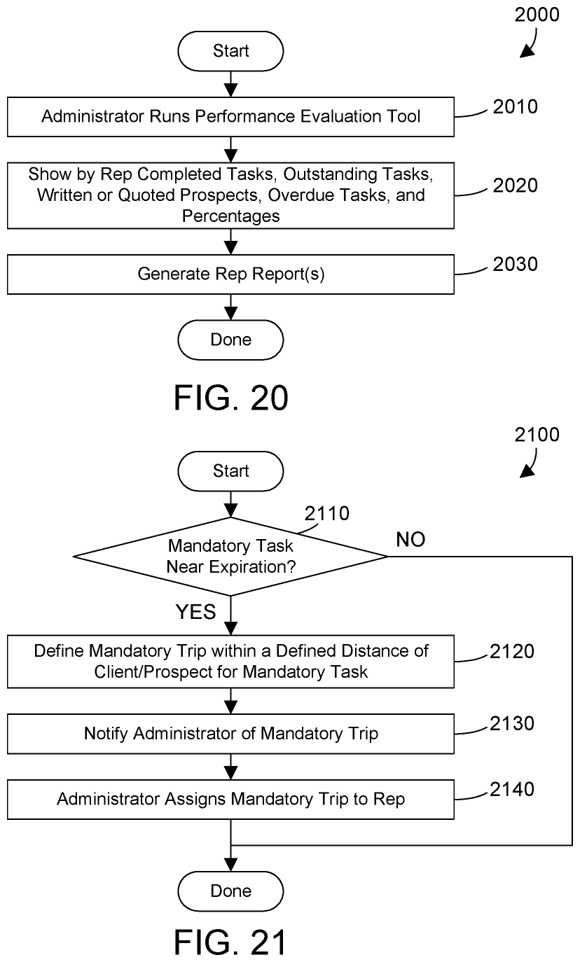

Referring to FIG. 20, a method 2000 is preferably performed by the client and prospect app 223 shown in FIG. 2. An administrator runs a performance evaluation tool (step 2010). The performance evaluation tool displays to the administrator by rep the completed tasks, outstanding tasks, written or quoted prospects, overdue tasks, and percentages (step 2020). One or more rep reports are then generated (step 2030). The performance evaluation tool provides metrics for measuring performance of reps, and can be a valuable tool for an administrator to evaluate the performance of the reps, especially when compared to each other.

Referring to FIG. 21, a method 2100 is preferably performed by the client and prospect app 223 shown in FIG. 2. When a mandatory task is near expiration (step 2110=YES), a mandatory trip is defined within a defined distance of the client or prospect corresponding to the mandatory task (step 2120). The mandatory trip defined in step 2120 preferably includes a specified route for the trip. The administrator is notified of the mandatory trip (step 2130). The administrator then assigns the mandatory trip to a rep (step 2140). Method 2100 is then done. Method 2100 provides a way to automatically generate a trip to satisfy one or more mandatory tasks before the mandatory tasks expire.

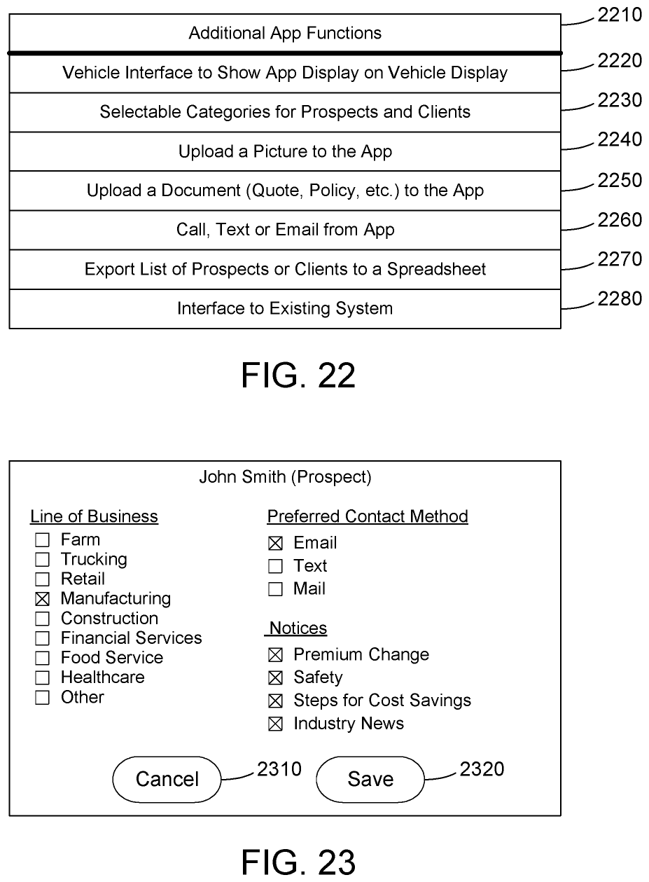

The client and prospect app disclosed herein can include many additional functions. Examples of some suitable additional functions are shown in the table 2210 in FIG. 22. Some of these functions are discussed below in the context of selling insurance, for the purpose of illustration. The app may include a vehicle interface that allows the app display to be shown on the vehicle display 2220. For example, Apple provides technology called Apple Car Play that allows displaying what is on an iPhone or iPad display on a vehicle display. Other types of phones and other mobile devices can provide similar functionality. For example, the app can include the capability of pairing to a vehicle using Bluetooth, and can then show the information on the app display to the vehicle display. Function 2220 in the app can include any suitable way for showing the app display on the vehicle display, whether currently known or developed in the future.

Another function the app could provide is to have selectable criteria or categories for prospects and clients 2230. These selectable categories can be useful in different contexts, such as in generating reports or in providing mass messages to clients and/or prospects, as discussed below in the detailed example in FIGS. 23-25. The app can also include the capability of uploading a picture taken on the mobile device to the app 2240. This can be very helpful, for example, when a rep defines a new prospect for a retail store, allowing the rep to upload a picture of the retail store to be stored as part of the information for the prospect. Similarly, the rep could take many pictures that are uploaded to the app at the time an insurance policy is written to document condition of a property at the time the policy is written. The app also supports uploading a document to the app, such as a quote, policy, or other document. Thus, when a rep provides a quote for an insurance policy, the quote can be part of the prospect information. When a rep writes an insurance policy, the policy signed by the new client can be uploaded to the app, which can then store the policy and change the prospect to a client in the system due to the signing of the policy.

The app also supports calling, sending a text message, or emailing from the app 2260. This allows the app to maintain a log of all communications with the clients and prospects contacted through the app. The app can also export a list of prospects and/or clients to a spreadsheet 2270. In addition, the app can include an interface to an existing system 2280 to keep information in the existing system and the new client and prospect management system in sync. This allows a rep, for example, to access client information in an existing system through the app before the client is ported to the new client and prospect management system.

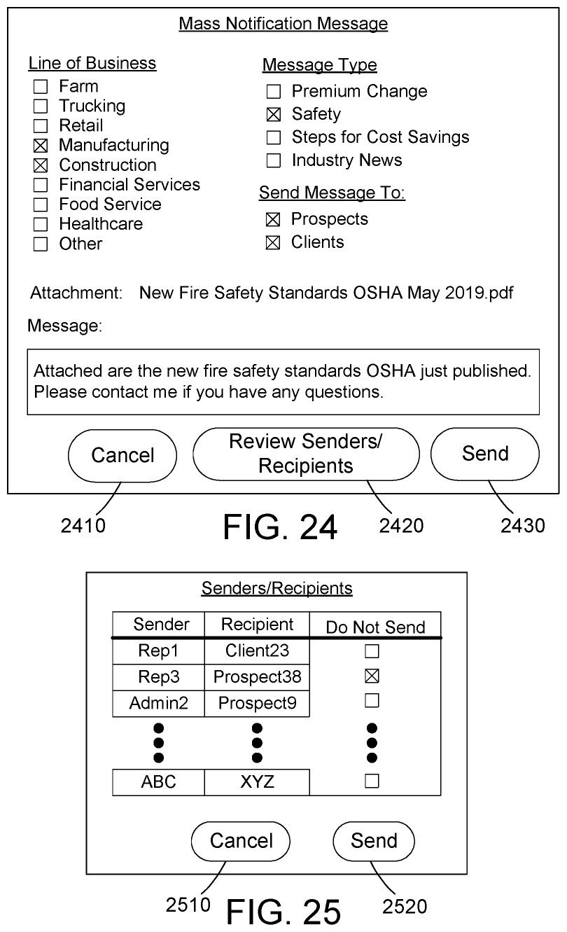

An example is now given to illustrate the benefits of providing selectable criteria, such as fields for clients and prospects. We assume a prospect named John Smith has been entered into the client and prospect management system. Several selectable fields for client John Smith are shown in FIG. 23. We assume a user could select a line of business, preferred contact method, and notice type for John Smith. In the specific example shown in FIG. 23, the selections are shown by boxes being checked. Thus, the line of business for John Smith is Manufacturing, the preferred contact method is Email, and the notice types include Premium Change, Safety, Steps for Cost Savings, and Industry News. By selecting the appropriate selectable fields for a client or prospect, as illustrated by way of example in FIG. 23, mass communications can be automatically generated and customized to the appropriate recipients from the appropriate senders. We assume for the example in FIG. 23 a rep that is assigned John Smith as a prospect has selected the checkboxes shown in FIG. 23, then clicks on the Save button 2320 to save this information for John Smith. In the alternative, the rep could click on the Cancel button 2310 to exit out of the display shown in FIG. 23. Mass communications can now be customized according to the selectable fields for the client, as shown in the simple example in FIGS. 24 and 25.

We assume an administrator receives notice of new fire safety standards that OSHA published in 2019. The administrator could then initiate a mass notification message to make all clients and prospects that have the Safety checkbox under Notices checked, as shown in FIG. 23. The administrator could target the mass communication message according to line of business. In FIG. 24, the administrator has selected Manufacturing and Construction as applicable lines of business for the mass communication message, has selected the message type of Safety, and has selected to send the message to both Prospects and Clients. An attachment New Fire Safety Standards OSHA May 2019.pdf is attached to the message. The administrator can also type a message, such as the one in FIG. 24 that states: “Attached are the new fire safety standards OSHA just published. Please contact me if you have any questions.” When the administrator wants this message and attachment sent to all prospects and clients that satisfy the selected line of business and message type, the administrator clicks on the Send button 2430. In response to clicking on the Send button 2430, the client and prospect management system will automatically generate a message for each client and prospect that satisfies the selected line of business and message type. For those that have email as their preferred contact method, the system automatically generates an email to the prospect or client from the assigned rep, and preferably copies the assigned rep. For those that have text as their preferred contact method, the system automatically generates a text message to the prospect or client from the assigned rep, and preferably copies the assigned rep. For those that have mail as their preferred contact method, the system automatically assigns a task to the assigned rep to mail the fire safety standards to the prospects and clients.

Instead of automatically sending the message to all recipients by clicking on the Send button 2430, the user can click on the Review Senders/Recipients button 2420, which will cause a list of senders and recipients to be displayed, allowing the user to select the message not be sent to certain recipients. We assume the user clicks on the Review Senders/Recipients button 2420 in FIG. 24, which results in the display shown in FIG. 25 being displayed to the user, which displays all senders and recipients of the message. The user can then click on the box Do Not Send for any particular recipient, which will result in the message not being sent. Once the user has made the desired selections in FIG. 25 to exclude the message from being sent to some recipients, the user clicks on the Send button 2520, which results in the message being send to all recipients except those that have Do Not Send checked. In the alternative, the user can click on the Cancel button 2510, which results in the user being taken back to the previous display, such as shown in FIG. 24.

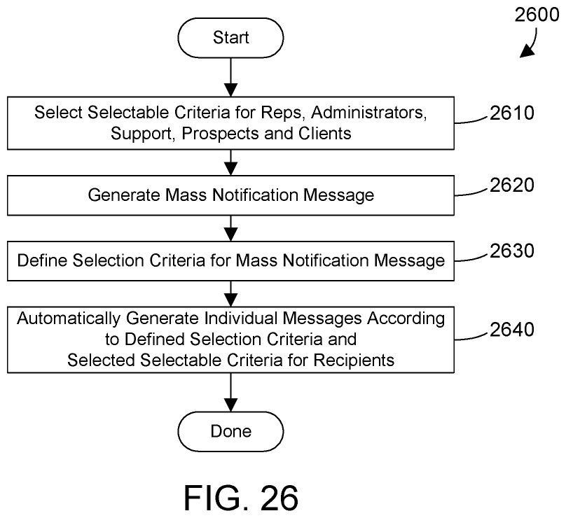

Referring to FIG. 26, a method 2600 is preferably performed by the message manager 229 in FIG. 2. One or more selectable criteria are selected for each rep, administrator, support, prospects and clients (step 2610). A mass notification message is generated (step 2620). Selection criteria is defined for the mass notification message (step 2630). Individual messages are then automatically generated according to the defined selection criteria and selected selectable criteria for recipients (step 2640). Method 26 is then done.

The mass messaging capability is very handy and useful, not only for clients and prospects but for reps and administrators as well. For example, if a training class is upcoming that an administrator wants all reps to attend, the administrator can send a message to all reps regarding the training class, and can tag the training class as mandatory, which will cause the system to put the training class on each rep's calendar automatically. When a rep wants to notify all other reps of some important information, the rep can do a mass message to all reps. When an administrator wants to schedule training for all reps that have less than six months work experience in the company, the administrator can generate a message for reps that fit that criteria. When a new policy rider is introduced, those customers and prospects in certain lines of business can be contacted to inform them of the new policy rider. If new crop insurance is offered, farmers can be notified of the new crop insurance and the requirements for qualifying for the crop insurance. The mass messaging discussed above is by way of illustration, and is not limiting. The disclosure and claims herein expressly extend to the automatic generation of messages for any suitable notification method using any suitable criteria to any set or recipients.

The disclosure herein provide examples where some functions are performed by the client and prospect app, such as 120A, . . . , 120N shown in FIG. 1, and other functions are performed by the client and prospect management system, such as 150 in FIG. 1. These specific examples are not limiting. Many of the functions of the client and prospect app could be performed instead by the client and prospect management system, and many or all of the functions of the client and prospect management system could be performed instead by the client and prospect app.

The disclosure and claims herein support an apparatus comprising: a processor; a memory coupled to the processor; a display coupled to the processor; and a client and prospect app residing in the memory and executed by the processor, the client and prospect app comprising a trip manager that allows defining a trip comprising a route between two geographical points on a map displayed on the display, the trip manager determining clients and prospects within a defined distance from the route, and displaying on the display the route and the clients and prospects within the defined distance from the route.

The disclosure and claims herein further support a method for an app to display information, the method comprising: allowing a user to define a trip comprising a route between two geographical points on a map displayed on the display; determining clients and prospects within a defined distance from the route; and displaying on the display the route and the clients and prospects within the defined distance from the route.

The disclosure and claims herein additionally support a method for an app to display information, the method comprising: allowing a user to define a trip comprising a route between two geographical points on a map displayed on the display; determining clients and prospects within a defined distance from the route; and displaying on the display the route and the clients and prospects within the defined distance from the route; displaying the clients and prospects on the display with different colors according to an expiration date defined for each client and prospect and a defined priority for at least one of the clients and prospects; allowing a user to select a location on a map; querying a property identification service that provides from public records ownership information for the selected location on the map; displaying the ownership information on the display; allowing an administrator to define mandatory tasks for each client and prospect and to define suggested tasks for each client and prospect; when a mandatory task is within a defined time period of expiration: defining a mandatory trip corresponding to the mandatory task; and notifying the administrator of the mandatory trip; when a user defines a trip with a route that is within the defined distance of a client or prospect corresponding to a mandatory task defined by the administrator: automatically assigning the mandatory task to the user; and displaying on the display the assigned mandatory task; when a user defines the trip, displaying on the display at least one suggested task defined by the administrator for a client or prospect within the defined distance of the route, allowing the user to accept the suggested task at the discretion of the user.

A client and prospect app is part of a client and prospect management system. The client and prospect app can run on many different systems, including computer systems in an office, tablet computers, smart phones, etc. The client and prospect app includes interfaces for sales reps, administrators and support staff. The client and prospect app includes the ability to define a route for a trip on a map, and to display clients and prospects within a defined distance of the route. An administrator can define mandatory and/or suggested tasks tied to geographical locations, and when a trip for a rep is defined with a route within a defined distance of those geographical locations, mandatory and suggested tasks can be automatically assigned to the rep making the trip and displayed on the map. The client and prospect app can also access a property identification service so a user of the app can click on a property on a map in the app, and the property identification service accesses public land records to identify the owner of the property and to display the owner information in the app. The client and prospect app can display clients and prospects on a map coded according to defined expiration dates, priority information or notes corresponding to clients and prospects. The client and prospect app also supports sending mass notification messages to users, clients and prospects using selectable criteria.

The app disclosed herein is especially useful for agencies selling insurance policies for homes, farms and businesses. However, the app could be used for reps, administrators and support staff of any type of business that has sales reps and that needs to track clients and prospects.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

1. An apparatus comprising:
a processor;
a memory coupled to the processor;
a display coupled to the processor; and
a client and prospect app residing in the memory and executed by the processor, the client and prospect app comprising a trip manager that allows defining a trip comprising a route between two geographical points on a map displayed on the display, the trip manager determining clients and prospects within a defined distance from the route, and displaying on the display the route and the clients and prospects within the defined distance from the route.

2. The apparatus of claim 1 wherein the clients and prospects displayed on the display have different attributes on the display according to an expiration date defined for each client and prospect.

3. The apparatus of claim 1 wherein the different attributes comprise different shapes of indicators on the display.

4. The apparatus of claim 1 wherein the different attributes comprise different colors of indicators on the display.

5. The apparatus of claim 1 wherein the clients and prospects displayed on the display have different attributes on the display according to a defined priority for at least one of the clients and prospects.

6. The apparatus of claim 5 wherein the different attributes comprise different shapes of indicators on the display.

7. The apparatus of claim 5 wherein the different attributes comprise different colors of indicators on the display.

8. The apparatus of claim 1 further comprising a location manager that allows selecting a location on a map, the location manager querying a property identification service that provides from public records ownership information for the selected location on the map, wherein the location manager displays the ownership information on the display.

9. The apparatus of claim 1 further comprising an administrator interface that allows an administrator to define mandatory tasks for each client and prospect and to define suggested tasks for each client and prospect.

10. The apparatus of claim 9 wherein, when a mandatory task is within a defined time period of expiration, the trip manager defines a mandatory trip corresponding to the mandatory task and notifies the administrator of the mandatory trip.

11. The apparatus of claim 9 wherein, when a user defines a trip with a route that is within the defined distance of a client or prospect corresponding to a mandatory task defined by the administrator, the mandatory task is automatically assigned to the user, and the location manager displays on the display the assigned mandatory task.

12. The apparatus of claim 9 wherein, when a user defines a trip with a route that is within the defined distance of a client or prospect corresponding to a suggested task defined by the administrator, the suggested task is displayed to the user on the display, allowing the user to accept the suggested task at the discretion of the user.

13. The apparatus of claim 1 further comprising a message manager that automatically creates from a mass notification message individual messages to a plurality of clients or prospects according to selectable criteria for the clients or prospects that has been selected.

14. The apparatus of claim 13 wherein the selectable criteria comprises line of business, preferred contact method, and notice type.

15. A method for an app to display information, the method comprising:
allowing a user to define a trip comprising a route between two geographical points on a map displayed on the display;
determining clients and prospects within a defined distance from the route; and
displaying on the display the route and the clients and prospects within the defined distance from the route.

16. The method of claim 15 further comprising displaying the clients and prospects on the display with different attributes according to an expiration date defined for each client and prospect.

17. The method of claim 15 wherein the different attributes comprise different shapes of indicators on the display.

18. The method of claim 15 wherein the different attributes comprise different colors of indicators on the display.

19. The method of claim 15 further comprising displaying the clients and prospects on the display with different attributes according to a defined priority for at least one of the clients and prospects.

20. The method of claim 19 wherein the different attributes comprise different shapes of indicators on the display.

21. The method of claim 19 wherein the different attributes comprise different colors of indicators on the display.

22. The method of claim 15 further comprising:
allowing a user to select a location on a map;
querying a property identification service that provides from public records ownership information for the selected location on the map; and
displaying the ownership information on the display.

23. The method of claim 15 further comprising allowing an administrator to define mandatory tasks for each client and prospect and to define suggested tasks for each client and prospect.

24. The method of claim 23 further comprising, when a mandatory task is within a defined time period of expiration:
defining a mandatory trip corresponding to the mandatory task; and
notifying the administrator of the mandatory trip.

25. The method of claim 23 wherein, when a user defines a trip with a route that is within the defined distance of a client or prospect corresponding to a mandatory task defined by the administrator:
automatically assigning the mandatory task to the user; and
displaying on the display the assigned mandatory task.

26. The method of claim 23 wherein, when a user defines the trip, displaying on the display at least one suggested task defined by the administrator for a client or prospect within the defined distance of the route, allowing the user to accept the suggested task at the discretion of the user.

27. The method of claim 15 further comprising a message manager that automatically creates from a mass notification message individual messages to a plurality of clients or prospects according to selectable criteria for the clients or prospects that has been selected.

28. The method of claim 27 wherein the selectable criteria comprises line of business, preferred contact method, and notice type.

29. A method for an app to display information, the method comprising:
allowing a user to define a trip comprising a route between two geographical points on a map displayed on the display;
determining clients and prospects within a defined distance from the route; and
displaying on the display the route and the clients and prospects within the defined distance from the route;
displaying the clients and prospects on the display with different colors according to an expiration date defined for each client and prospect and a defined priority for at least one of the clients and prospects;
allowing a user to select a location on a map;
querying a property identification service that provides from public records ownership information for the selected location on the map;
displaying the ownership information on the display;
allowing an administrator to define mandatory tasks for each client and prospect and to define suggested tasks for each client and prospect;
when a mandatory task is within a defined time period of expiration:
defining a mandatory trip corresponding to the mandatory task; and
notifying the administrator of the mandatory trip;
when a user defines a trip with a route that is within the defined distance of a client or prospect corresponding to a mandatory task defined by the administrator:
automatically assigning the mandatory task to the user; and
displaying on the display the assigned mandatory task;
when a user defines the trip, displaying on the display at least one suggested task defined by the administrator for a client or prospect within the defined distance of the route, allowing the user to accept the suggested task at the discretion of the user.
